(19) United States
(12) Patent Application Publication
(10) Pub. No.: US 2016/0091916 A1
(43) Pub. Date: Mar. 31, 2016

(54) Bandgap Circuits and Related Method

(71) Applicant: Taiwan Semiconductor Manufacturing Company, Ltd., Hsin-Chu (TW)

(72) Inventors: Chin-Ho Chang, Hsin-Chu (TW); Jaw-Juinn Horng, Hsin-Chu (TW); Yung-Chow Peng, Hsin-Chu (TW)

(21) Appl. No.: 14/502,861

(22) Filed: Sep. 30, 2014

(51) Int. Cl. G05F 3/26; G05F 1/46

(52) U.S. Cl. CPC G05F 3/262; G05F 1/46

(57) ABSTRACT

A device includes a bandgap reference stage, a mirror current source, a voltage control circuit, and a resistive device. The mirror current source has a control terminal electrically coupled to an internal node of the bandgap reference stage. The voltage control circuit includes a first terminal electrically coupled to a second internal node of the bandgap reference stage, and a second terminal electrically coupled to a first terminal of the mirror current source. The resistive device has a first terminal electrically coupled to a third terminal of the voltage control circuit.

### BACKGROUND

The semiconductor industry has experienced rapid growth due to improvements in the integration density of a variety of electronic components (e.g., transistors, diodes, resistors, capacitors, etc.). For the most part, this improvement in integration density has come from shrinking the semiconductor process node (e.g., shrinking the process node towards the sub-20 nm node).

Shrinking the semiconductor process node entails reductions in operating voltage and current consumption of electronic circuits developed in the semiconductor process node. For example, operating voltages have dropped from 5V to 3.3V, 2.5V, 1.8V, 0.9V, etc. A wave of mobile device popularity has increased pressure in the industry to develop low power circuits that drain miniscule operating current from batteries that power the mobile devices. Lower operating current extends battery life of battery-operated mobile devices, such as smartphones, tablet computers, ultrabooks, and the like.

### BRIEF DESCRIPTION OF THE DRAWINGS

For a more complete understanding of the present embodiments, and the advantages thereof, reference is now made to the following descriptions taken in conjunction with the accompanying drawings, in which:

FIG. 1 is a diagram of a bandgap reference circuit in accordance with one or more embodiments of the present disclosure;

FIG. 2 is a diagram of another bandgap reference circuit in accordance with one or more embodiments of the present disclosure; and

FIG. 3 is a flowchart diagram of a method of operating the bandgap reference circuit of FIG. 1 or FIG. 2 in accordance with one or more embodiments of the present disclosure.

### DETAILED DESCRIPTION

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosed subject matter, and do not limit the scope of the different embodiments.

Embodiments will be described with respect to a specific context, namely pull-up circuits and related methods. Other embodiments may also be applied, however, to other types of pull-up circuits.

In the following disclosure, a novel bandgap reference circuit and method are introduced. The bandgap reference circuit uses a voltage control circuit to achieve low output voltage temperature variation at low power operation.

Bandgap reference circuits provide reference electrical voltage or current that is ideally independent of process, voltage, and temperature (PVT) variation. This is accomplished by generating an electrical current that is the sum of a proportional-to-absolute-temperature (PTAT) current and a complementary-to-absolute-temperature (CTAT) current. The PTAT current increases with rising temperature, and decreases with falling temperature. The CTAT current, on the other hand, decreases with rising temperature, and increases with falling temperature. Through proper circuit design, the PTAT current and the CTAT current can be balanced, so that the PVT variation of each of the two currents cancels out when summed. Use of two bipolar junction transistors (BJTs) in one or more of the embodiments described herein allows for generation of a base-emitter voltage (VBE), which exhibits CTAT behavior, and a difference of VBEs (ΔVBE), which exhibits PTAT behavior. A current mirror transistor of the bandgap reference circuit mirrors the summed current, which is provided by a reference current source transistor. At low supply voltage, the reference current source and current mirror transistors operate in the linear region, which would normally introduce unwanted variation in the mirrored current. A voltage control circuit is introduced herein which controls biasing levels of the current mirror transistor, so that the biasing levels are equal to biasing levels of the reference current source transistor. The equal biasing levels ensure that the mirrored current closely tracks any variations in the summed current.

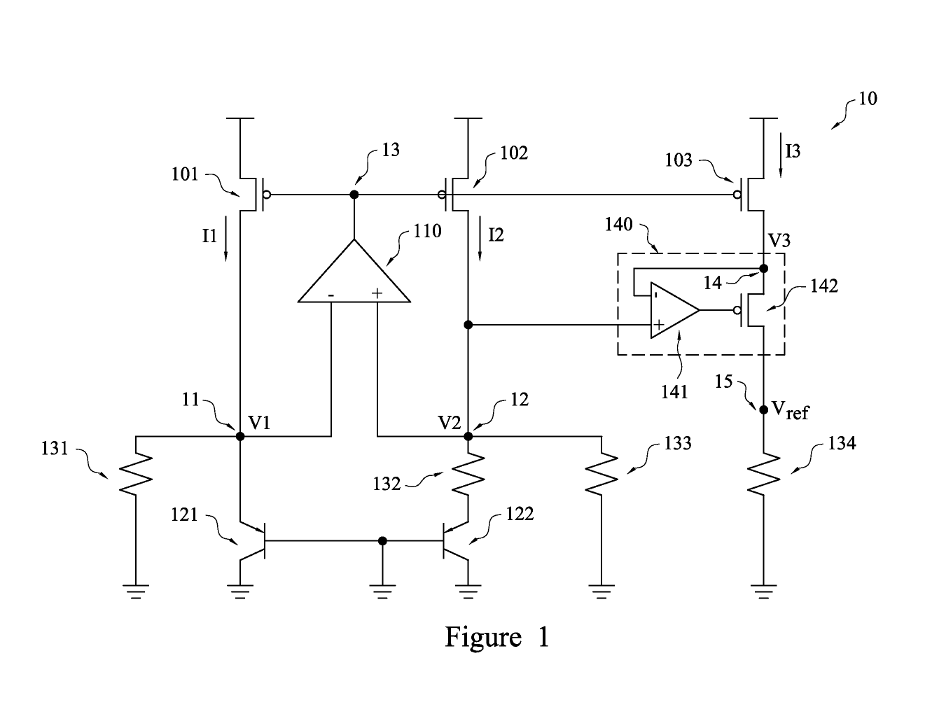

FIG. 1 is a diagram showing a bandgap reference circuit 10 in accordance with one or more embodiments of the present disclosure. In some embodiments, the bandgap reference circuit 10 is included in an integrated circuit chip, a computing device, or other electronic device. Embodiments in which other electronic devices include the bandgap reference circuit 10 are also contemplated herein.

A transistor 101 of the bandgap reference circuit 10 is electrically coupled to a transistor 102 and a transistor 103 of the bandgap reference circuit 10. The transistor 101 is a current source that supplies first current I1 to a first bipolar junction transistor (BJT) 121 and a first resistive device 131. A source electrode of the transistor 101 is electrically coupled to a first voltage supply node. In some embodiments, the first voltage supply node is an integrated circuit pad. In some embodiments, the first voltage supply node is supplied with a first supply voltage VDD. In some embodiments, the first supply voltage VDD is a voltage supplied to the bandgap reference circuit 10 for powering (biasing) the bandgap reference circuit 10. In some embodiments, the first supply voltage VDD is less than about 1.25 Volts. In some embodiments, the first supply voltage VDD is less than about 0.9 Volts. Embodiments having other values for the first supply voltage VDD that are greater than 1.25 Volts or less than 0.9 Volts are also contemplated herein. A gate electrode of the transistor 101 is electrically coupled to a gate electrode of the transistor 102. In some embodiments, the transistor 101 is a P-type metal-oxide-semiconductor (PMOS) transistor. In some embodiments, the transistor 101 operates in a linear region. In a non-limiting example, the first supply voltage VDD is sufficiently low for drain-source voltage (VDS) of the transistor 101 to be less than drain saturation voltage (VDSAT) or overdrive voltage (VOD) of the transistor 101. An example of the overdrive voltage is source-gate voltage (VSG) minus threshold voltage (VTH) of a PMOS transistor. For the transistor 101 operating in the linear region, the first supply voltage VDD is less than the sum of the overdrive voltage VOD and base-emitter voltage (VBE) of the first BJT 121.

The transistor 102 sources a second current I2 to a second BJT 122, and resistive devices 132, 133. In some embodiments, a source electrode of the transistor 102 is electrically coupled to the first voltage supply node. A gate electrode of the transistor 102 is electrically coupled to the gate electrode of the transistor 101. In some embodiments, the transistor 101 and the transistor 102 are of substantially the same size. Under similar biasing conditions, the transistors 101, 102 having the same size generate similar drain currents. In some embodiments, the transistor 101 and the transistor 102 having the same size have substantially equal channel length and width. In an integrated circuit, process variation can cause two transistors having the same layout dimensions (e.g., channel length and width) to exhibit mismatch after fabrication. In one non-limiting example, the width and channel length of the transistor 101 are each within less than ±10% of width and channel length of the transistor 102, respectively. The mismatch in size between the transistors 101, 102 will vary based on semiconductor fabrication process, layout style, and layout dimensions. In some embodiments, the transistor 102 is a PMOS transistor.

The first BJT 121 provides a base-emitter voltage (VBE) that is complementary to absolute temperature (CTAT). The base-emitter voltage (VBE) is commonly expressed as:

$$V B E = \frac{kT}{q} ln ( \frac{{I}_{C}}{{I}_{S}} ) ,$$

where I_{C} is collector current, and I_{S} is reverse saturation current. While VBE includes a term (kT/q) that is directly proportional to temperature (T), inverse proportionality of the reverse saturation current I_{S} dominates the equation, such that overall VBE temperature dependence is CTAT.

An emitter electrode of the first BJT 121 is electrically coupled to the drain electrode of the transistor 101 and the first input terminal of the amplifier circuit 110. A collector electrode of the first BJT 121 is electrically coupled to a second voltage supply node. In some embodiments, the second voltage supply node is an integrated circuit pad (e.g., a ground pad, or a VSS pad). The base electrode of the first BJT 121 is electrically coupled to the second voltage supply node.

The second BJT 122 establishes a second VBE based on the second current I2 supplied by the transistor 102. An emitter electrode of the second BJT 122 is electrically coupled to the drain electrode of the transistor 102 and the second input terminal of the amplifier circuit 110 through a resistive device 132. In some embodiments, the resistive device 132 is an integrated resistor. In some embodiments, an integrated resistor is a resistive circuit element that is fabricated in an integrated circuit process, such as a complementary metal-oxide-semiconductor (CMOS) process. In some embodiments, the resistive device 132 is a polysilicon resistor or a diffused resistor. Embodiments in which other types of resistors are used for the resistive device 132 are also contemplated herein. A first terminal of the resistive device 132 is electrically coupled to the drain electrode of the transistor 102 and the second input terminal of the amplifier circuit 110. A second terminal of the resistive device 132 is electrically coupled to the emitter electrode of the second BJT 122. A collector electrode of the second BJT 122 is electrically coupled to the second voltage supply node. In some embodiments, the first BJT 121 is a PNP-type BJT. In some embodiments, the second BJT 122 is a PNP-type BJT. The base electrode of the second BJT 122 is electrically coupled to the second voltage supply node.

An amplifier circuit 110 regulates first voltage V1 at a drain electrode of the transistor 101 to be equal to second voltage V2 at a drain electrode of the transistor 102. A first input terminal (e.g., an inverting input terminal) of the amplifier circuit 110 is electrically coupled to the drain electrode of the transistor 101 (node 11). A second input terminal (e.g., a non-inverting input terminal) of the amplifier circuit 110 is electrically coupled to the drain electrode of the transistor 102 (node 12). An output terminal of the amplifier circuit 110 is electrically coupled to the gate electrode of the transistor 101 and the gate electrode of the transistor 102. In some embodiments, the amplifier circuit 110 is an operational amplifier.

The transistors 101, 102 form closed-loop feedback around the amplifier circuit 110, which forces the first voltage V1 to equal the second voltage V2. As one example, when the second voltage V2 increases to a level higher than the first voltage V1, the amplifier increases the voltage at the gate electrodes of the transistors 101, 102. The increased voltage at the gate electrodes of the transistors 101, 102 reduces the first and second currents I1, I2. The reduction in the first and second currents I1, I2 brings the second voltage V2 down relative to the first voltage V1 to regain equality between the first and second voltages V1, V2.

The amplifier circuit 110 holds the second voltage V2 equal to VBE of the first BJT 121 (or “VBE1”). The second current I2 is then equal to (VBE1−VBE2)/R₁₃₂, where VBE2 is VBE of the second BJT 122, and R₁₃₂ is resistance of the resistive device 132. Current flowing through the resistive device 132, being a function of ΔVBE (the term VBE1−VBE2), is PTAT.

In some embodiments, the bandgap reference circuit 10 further includes resistive devices 131, 133. A first terminal of the resistive device 131 is electrically coupled to the drain electrode of the transistor 101 and the first input terminal of the amplifier circuit 110. A second terminal of the resistive device 131 is electrically coupled to the second voltage supply node (e.g., ground). A first terminal of the resistive device 133 is electrically coupled to the drain electrode of the transistor 102 and the second input terminal of the amplifier circuit 110. A second terminal of the resistive device 133 is electrically coupled to the second voltage supply node (e.g., ground). In some embodiments, the resistive devices 131, 133 are polysilicon resistors, diffused resistors, or the like. Embodiments in which other types of resistors are used for the resistive devices 131, 133 are also contemplated herein. In embodiments including the resistive devices 131, 133, the second current I2 is given by:

$$I 2 = \frac{{V}_{T} ln n}{{R}_{132}} + \frac{{VBE}_{121}}{{R}_{133}} ,$$

where V_{T} is the thermal voltage, n is ratio of size of the second BJT 122 to size of the first BJT 121, R₁₃₂ is resistance of the resistive device 132, VBE₁₂₁ is base-emitter voltage of the first BJT 121, and R₁₃₃ is resistance of the resistive device 133. The first term of the equation for the second current I2 is proportional to absolute temperature (PTAT), and the second term is complementary to absolute temperature (CTAT). Proper design of the ratio n, and the resistive devices 131, 132, 133 allows the second current I2 to be mostly constant over a large range of processes, voltages, and temperatures (PVT).

In one or more embodiments, a bandgap reference stage includes the transistors 101, 102, the amplifier circuit 110, the first and second BJTs 121, 122, and the resistive device 132. In some embodiments, the bandgap reference stage further includes the resistive devices 131, 133. In some embodiments, the bandgap reference stage is one circuit stage of a larger bandgap reference circuit. In some embodiments, the bandgap reference stage is a first stage, which proceeds a second stage. In some embodiments, the second stage includes, for example, a source follower circuit, or other type of amplification circuit.

A gate electrode of the transistor 103 is electrically coupled to the gate electrode of the transistor 101 and the gate electrode of the transistor 102. Because the gate electrode of the transistor 103 is electrically coupled to the gate electrode of the transistor 102, the transistor 103 mirrors the second current I2 to generate a third current I3. Further, because gate electrodes of the transistors 101, 102, 103 are all directly biased by voltage at the node 13, gate voltage of the transistors 101, 102, 103 is the same. A source electrode of the transistor 103 is electrically coupled to the first voltage supply node. Source voltage of the transistors 101, 102, 103 is the same (source electrodes of the transistors 101, 102, 103 are all directly biased by the first supply voltage at the first voltage supply node). In some embodiments, the transistor 103 is a PMOS transistor. In some embodiments, the transistor 101 and the transistor 103 have substantially the same size. As discussed above, layout dimensions of the transistors 101, 103 can be substantially the same, and physical dimensions of the transistors 101, 103 in an integrated circuit (IC) after fabrication can exhibit mismatch dependent on fabrication process, layout style, and layout dimensions.

The gate and source voltages are the same for the transistors 101, 102, 103, as just described. In some embodiments, the dimensions of the transistors 101, 102, 103 are substantially the same. In the linear region, PMOS transistor drain current is given by:

$${I}_{D} = {μ}_{p} {C}_{ox} \frac{W}{L} ( ( {V}_{SG} - {V}_{thp} ) {V}_{SD } - \frac{{V}_{SD}^{2}}{2} ) ,$$

where μₚ is the charge-carrier effective mobility, W is the gate width, L is the gate length (or “channel length”), Cₒₓ is the gate oxide capacitance per unit area, and Vₜₕₚ is the PMOS threshold voltage. The drain current in the linear region is correlated with the source-drain voltage V_{SD}. In addition to designing W, L and V_{SG} to be equal for all of the transistors 101, 102, 103, controlling the source-drain voltage V_{SD} of the transistors 101, 102, 103 ensures that the drain currents (the first, second, and third currents I1, I2, I3) generated by the transistors 101, 102, 103 are uniform.

To set the voltage at the drain electrode of the transistor 103 to be equal to the voltage at the drain electrode of the transistor 102, the bandgap reference circuit 10 further includes a voltage control circuit 140. The voltage control circuit 140 controls voltage at the drain electrode of the transistor 103. In some embodiments, the voltage control circuit 140 holds the voltage V3 at the drain electrode of the transistor 103 to a level equal to the second voltage V2 (i.e., voltage at the drain electrode of the transistor 102). Explained in a different way, the voltage V3 at the drain electrode of the transistor 103 tracks the voltage V2. For example, the voltage V3 increases when the voltage V2 increases, and decreases when the voltage V2 decreases. Other circuits performing the same function as the voltage control circuit 140 are also within the scope of the disclosure.

The voltage control circuit 140 also regulates a source-drain voltage of the transistor 103 to be substantially equal to a source-drain voltage of the transistor 102. The voltage control circuit 140 is electrically coupled to the drain electrode of the transistor 102, the drain electrode of the transistor 103, and an output node 15 of the bandgap reference circuit 10. In some embodiments, the source-drain voltages of the transistors 101, 102, 103 are regulated to be within a predetermined value of each other by the voltage control circuit 140 and the amplifier circuit 110. In some embodiments, the source-drain voltages of the transistors 101, 102, 103 are regulated to within less than 5% of each other. In some embodiments, the source-drain voltages of the transistors 101, 102, 103 are regulated to within less than 1% of each other. Other predetermined values are also within the scope of the disclosure. Trade-offs can be made by a designer of the voltage control circuit 140 between area, power consumption, and regulation performance. For example, a gain in regulation performance may be accomplished by sacrificing area or power consumption.

Because the voltage V3 at the drain electrode of the transistor 103 closely tracks the voltage V2 at the drain electrode of the transistor 102, the current I3 conducted by the transistor 103 closely tracks the current I2 conducted by the transistor 102. This is desirable so that, even if the transistors 101, 102, 103 are operated in the linear region, reference voltage Vref of the bandgap reference circuit 10 is kept very stable. Simulation data shows that temperature variation of the reference voltage Vref generated by the bandgap reference circuit 10 including the voltage control circuit 140 is less than 20 ppm/° C. (“ppm”=“parts per million”). As one non-limiting example, if the reference voltage Vref is designed to be nominally 1 Volt, the reference voltage Vref varies by less than 1.4 millivolts (mV) over a 70° C. temperature range (70*20/1,000,000=0.0014). More detailed description of the voltage control circuit 140 and its functionality follow.

An amplifier circuit 141 of the voltage control circuit 140 amplifies voltage differences between the second voltage V2 and the third voltage V3. A transistor 142 of the voltage control circuit 140 establishes a negative feedback loop around the amplifier circuit 141 to force the third voltage V3 to equal the second voltage V2. A first input terminal (e.g., an inverting input terminal) of the amplifier circuit 141 is electrically coupled to the drain electrode of the transistor 103 and the source electrode of the transistor 142. A second input terminal (e.g., a non-inverting input terminal) of the amplifier circuit 141 is electrically coupled to the drain electrode of the transistor 102 and the second input terminal of the amplifier circuit 110. An output terminal of the amplifier circuit 141 is electrically coupled to a gate electrode of the transistor 142. Simulation data shows that chip area of the amplifier circuit 141 can be less than 10% of chip area of all other components shown in FIG. 1 while maintaining the same performance described above. Embodiments in which a larger or smaller size is designed for the amplifier circuit 141 are also contemplated herein. The designer can trade off chip area, power consumption, and circuit performance to achieve the desired overall circuit performance of the bandgap reference circuit 10. A second terminal of the resistive device 134 is electrically coupled to the second voltage supply node (e.g., ground).

A source electrode of the transistor 142 of the voltage control circuit 140 is electrically coupled to the drain electrode of the transistor 103 (node 14). A drain electrode of the transistor 142 is electrically coupled to a first terminal of a resistive device 134. In some embodiments, the transistor 142 is a PMOS transistor. In some embodiments, the resistive device 134 is a polysilicon resistor or a diffused resistor. Embodiments in which the resistive device is another type of resistor are also contemplated herein.

Based on the above equation for the second current I2, the reference voltage Vref at the node 15 can be expressed as:

Vref=R₁₃₄mI2,

where R₁₃₄ is resistance of the resistive device 134, and m is a size ratio between the transistor 103 and the transistor 102 (or the transistor 101). In some embodiments, m is 1. Other embodiments in which m is greater than or less than 1 are also contemplated herein. The product m*I2 is the third current I3.

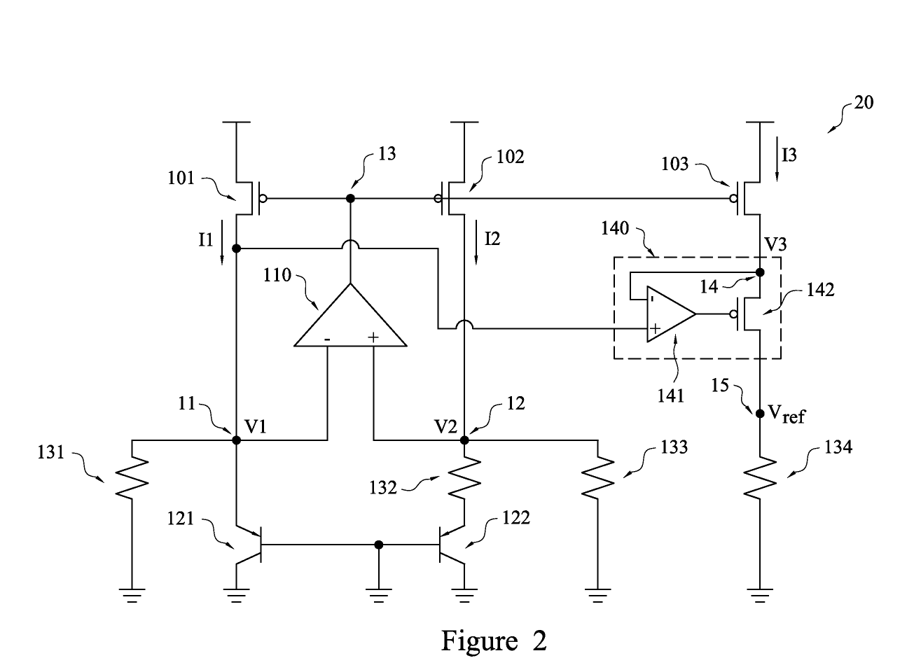

FIG. 2 is a diagram showing a device 20 in accordance with one or more embodiments of the present disclosure. The device 20 is similar in many aspects to the bandgap reference circuit 10, and like reference numerals refer to like components. In some embodiments, the second input terminal of the amplifier circuit 141 is electrically coupled to the drain electrode of the transistor 101. Because the voltage V1 at the node 11 is equal to the voltage V2 at the node 12, electrically coupling the second input terminal of the amplifier circuit 141 to the drain electrode of the transistor 101 achieves the same effect as the configuration shown in FIG. 1 in which the second input terminal of the amplifier circuit 141 is electrically coupled to the node 12.

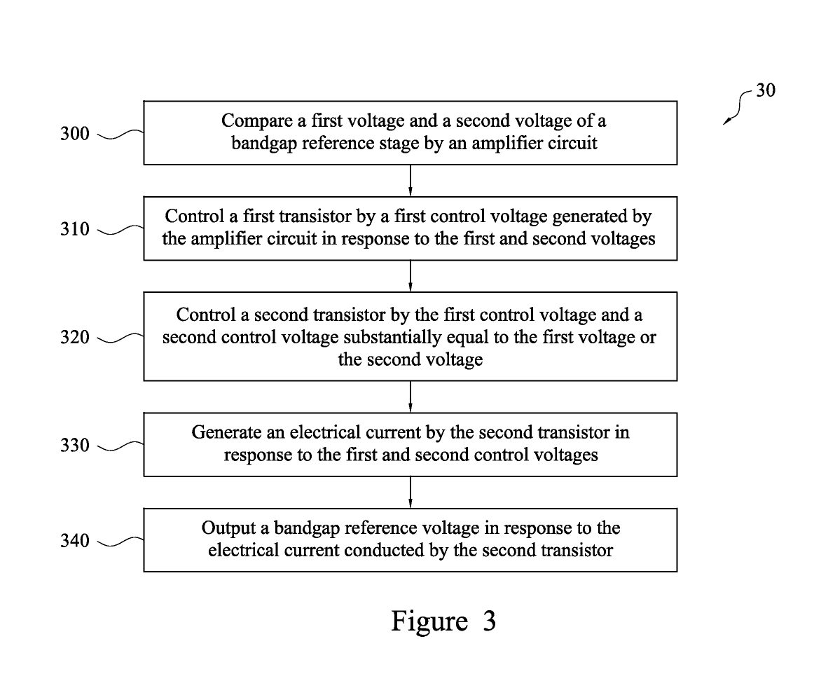

FIG. 3 is a flowchart diagram of a method 30 for operating a device (e.g., the bandgap reference circuit 10 or the device 20) in accordance with one or more embodiments of the present disclosure. Reference to the FIG. 1 or FIG. 2 is made for illustrative purposes, but the method 30 should not be construed as limited to the devices 10, 20 shown therein.

The amplifier circuit 110 compares the first voltage V1 and the second voltage V2 of the bandgap reference stage in operation 300. In some embodiments, the bandgap reference stage includes the transistors 101, 102, amplifier circuit 110, resistors 131, 132, 133, and BJTs 121, 122 arranged as shown in FIG. 1 or FIG. 2. In some embodiments, the amplifier circuit 110 that compares the first voltage to the second voltage is an operational amplifier circuit. In some embodiments, the amplifier circuit compares the base-emitter voltage VBE1 of the first BJT 121 to the sum of the base-emitter voltage VBE2 of the second BJT 122 and a resistor voltage V₁₃₂ (voltage across the resistive device 132).

The amplifier circuit 110 generates a first control voltage VC1 (e.g., voltage at the node 13 corresponding to the output terminal of the amplifier circuit 110) in response to the first and second voltages V1, V2. The first control voltage VC1 controls the transistor 102 of the bandgap reference stage. In some embodiments, the first control voltage VC1 controls the source-gate voltage VSG of the transistor 102 by establishing a gate voltage at a gate electrode of the transistor 102. In some embodiments, the first control voltage VC1 controls amplitude of the second current I2 of the transistor 102. In some embodiments, when the first control voltage VC1 is increased, the second current I2 of the transistor 102 is decreased. In some embodiments, when the first control voltage VC1 is decreased, the second current I2 of the transistor 102 is increased. The amplifier circuit 110 can be said to regulate the second current I2 of the transistor 102. For example, if a change in temperature increases the second voltage V2, the amplifier circuit 110 increases the first control voltage VC1 to decrease the second current I2 that flows through the resistive device 132 that establishes the resistor voltage V₁₃₂.

The transistor 103 is controlled by the first control voltage VC1 and a second control voltage (e.g., the third voltage V3) substantially equal to the first voltage V1 or the second voltage V2 in operation 320. In some embodiments, the transistor 103 is controlled by the first voltage V1 and the second control voltage V3 substantially equal to the second voltage V2 (e.g., as shown in FIG. 1). In some embodiments, the second control voltage V3 is established by the voltage control circuit 140 in response to the second voltage V2. In some embodiments, the voltage control circuit 140 establishes the second control voltage V3 by the amplifier circuit 141. In some embodiments, the second amplifier circuit regulates the drain voltage (e.g., the third voltage V3) of the transistor 103 by the transistor 142. In some embodiments, the amplifier circuit 141 controls the gate voltage of the transistor 142 in response to a change in the second voltage V2 or a change in the second control voltage V3.

The current I3 is generated by the transistor 103 in response to the first and second control voltages VC1, V3 in operation 330. In some embodiments, the third current I3 is generated by a PMOS transistor (the transistor 103) in response to the first control voltage VC1 established at the gate electrode of the PMOS transistor 103, and the second control voltage V3 established at the drain electrode of the PMOS transistor 103. In some embodiments, the third current I3 is generated by the transistor 103 which is electrically biased substantially the same as the transistor 102 (substantially similar gate, source and drain voltages). In some embodiments, the transistor 103 generates the third current I3 while operating in the linear region.

The bandgap reference voltage Vref is outputted in response to the third current I3 conducted by the transistor 103 in operation 340. In some embodiments, the bandgap reference voltage Vref is established by flowing the third current through the resistive device 134.

Embodiments may achieve advantages. The bandgap reference circuits 10, 20 and related method 30 are capable of generating a very stable (less than about 20 ppm/° C. temperature coefficient) reference voltage Vref even in very low power operation (e.g., power supply is less than about 0.9 Volts). Stability of the reference voltage Vref is maintained even if the transistor 103 is operated in the linear region.

In accordance with one or more embodiments of the present disclosure, a device includes a bandgap reference stage, a mirror current source, a voltage control circuit, and a resistive device. The bandgap reference stage is configured to generate a first current, a first control voltage, and a first voltage. The mirror current source is configured to generate a second current in response to the first control voltage and a second control voltage. The voltage control circuit is configured to force the second control voltage to substantially equal the first voltage. The resistive device is configured to generate a reference voltage in response to the second current.

In accordance with one or more embodiments of the present disclosure, a device includes an amplifier circuit, first, second and third transistors, a voltage control circuit, and a resistive device. The first transistor has a control terminal electrically coupled to an output terminal of the amplifier circuit, and a first terminal electrically coupled to an inverting input terminal of the amplifier circuit. The second transistor has a control terminal electrically coupled to the output terminal of the amplifier circuit, and a first terminal electrically coupled to a non-inverting input terminal of the amplifier circuit. The third transistor has a control terminal electrically coupled to the output terminal of the amplifier circuit. The voltage control circuit has a first terminal electrically coupled to a first terminal of the third transistor, and a second terminal electrically coupled to the inverting input terminal of the amplifier circuit. The resistive device has a first terminal electrically coupled to a third terminal of the voltage control circuit.

In accordance with one or more embodiments of the present disclosure, a method includes comparing a first voltage and a second voltage of a bandgap reference stage by an amplifier circuit of the bandgap reference stage; controlling a first transistor by a first control voltage generated by the amplifier circuit in response to the first and second voltages; controlling a second transistor by the first control voltage and a second control voltage substantially equal to the first voltage of the second voltage; generating an electrical current by the second transistor in response to the first and second control voltages; and outputting a bandgap reference voltage in response to the electrical current conducted by the second transistor.

As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”. Moreover, the term “between” as used in this application is generally inclusive (e.g., “between A and B” includes inner edges of A and B).

Although the present embodiments and their advantages have been described in detail, it should be understood that one or more changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A device for generating a bandgap reference voltage, comprising:
a current mirror circuit configured to generate a control current, wherein the current mirror circuit includes at least one transistor;
an amplifier coupled to the current mirror configured to generate a control voltage to control the current mirror;
a voltage control circuit coupled to the current mirror circuit and the amplifier configured to control the bandgap reference voltage based on the control current; and
an output circuit coupled to the voltage control circuit configured to generate the bandgap reference voltage;
wherein the bandgap reference voltage is kept stable when the at least one transistor operates in a linear region.

2. The device of claim 1, wherein the current mirror circuit includes the at least one transistor configured to generate a first current, a second transistor configured to generate a second current, and a third transistor configured to generate the control current, wherein each of the at least one, the second, and the third transistor has a first terminal tied to a power supply node and a gate terminal tied to a common node.

3. The device of claim 2, wherein: the amplifier includes on output terminal tied to the common node.

4. The device of claim 2, wherein the first current drives a voltage node tied to a first input terminal of the amplifier and the second current drives a second voltage node tied to a second input terminal of the amplifier.

5. The device of claim 1, further comprising:
at least one element having a complementary to absolute temperature (CTAT) voltage response curve.

6. The device of claim 5 wherein the at least one element includes two bipolar junction transistors.

7. The device of claim 1, wherein the output circuit comprises a resistor.

8. The device of claim 1, wherein the at least one transistor is a PMOS transistor in the current mirror circuit.

9. A device for generating a bandgap reference voltage, comprising:
a first circuit configured to generate a control current, a first node voltage and a second node voltage, the first circuit including a transistor;
a feedback path configured to maintain the first node voltage and the second node voltage substantially equal;
a second circuit configured to generate the bandgap reference voltage from the control current; and
a second feedback path configured to adjust the bandgap reference voltage by comparing the control current and an intermediate current generated by the first circuit, wherein the first circuit, the feedback path, the second circuit, and the second feedback path are configured to generate a stable bandgap reference voltage when the transistor operates in the linear region.

10. The device of claim 9, wherein the first circuit comprises;
a plurality of transistors, each of the transistors having a first respective terminal tied to a common power supply node and each of the transistors having a respective control terminal tied to a common node.

11. The device of claim 10, wherein the feedback path comprises an amplifier having an inverting input tied to a second terminal of one of the plurality of the transistors, a non-inverting input tied to a second terminal of a second one of the plurality of the transistors, and an output tied to the common node.

12. The device of claim 9, wherein the second circuit comprises a resistor tied to a node upon which the first circuit generates the control current.

13. The device of claim 9, wherein the second feedback path comprises:
a feedback transistor having a first terminal tied to a node upon which the first circuit generates the control current, a second terminal tied to the second circuit, and a control terminal tied to a second amplifier; and
the second amplifier, having an inverting input tied to the node upon which the first circuit generates the control current, a non-inverting input tied to the second node voltage, and an output terminal tied to a control input of the feedback transistor.

14. The device of claim 9, wherein:
the first circuit includes a first transistor having a source terminal connected to a voltage supply node, a drain terminal connected to a first intermediate node, and a gate terminal connected to a common node, a second transistor having a second source terminal connected to the voltage supply node, a second drain terminal connected to a second intermediate node, and a gate terminal connected to the common node, and a third transistor having a third source terminal connected to the voltage supply node, a third drain terminal connected to a third intermediate node, and a third gate terminal connected to the common node;
the feedback path includes an amplifier having an inverting input connected to the first intermediate node, a non-inverting input connected to the second intermediate node, and an output driving the common node;
the second circuit includes a resistor; and
the second feedback path includes a second amplifier having an inverting input connected to the third intermediate node, a non-inverting input connected to the second intermediate node, and an output driving a gate terminal of a fourth transistor, the fourth transistor having a source terminal connected to the drain terminal of the third transistor and having a drain terminal connected to the resistor.

15. The device of claim 14, further comprising:
a first bipolar transistor and a second resistor tied in parallel between the first intermediate node and a second voltage supply node;
a second bipolar transistor and a third resistor tied in series between the second intermediate node and the second voltage supply node; and
a fourth resistor tied between the second intermediate node and the second voltage supply node.

16. The device of claim 15, wherein the first bipolar transistor has a base-emitter voltage response curve that is complementary to absolute temperature.

17. The device of claim 15, wherein the first bipolar transistor has a first base-emitter voltage response curve that is complementary to absolute temperature, the second bipolar transistor has a second base-emitter voltage response curve that is complementary to absolute temperature, and a difference between the first base-emitter voltage response curve and the second base-emitter voltage response curve is proportional to absolute temperature.

18. A method of generating a bandgap reference voltage, comprising:
generating a first current at a first node and a second current at a second node using at least one transistor operating in a linear region;
feeding back a voltage at the first node and a second voltage at the second node to maintain the first current substantially equal to the second current;
mirroring the second current to generate a third current at a third node; and
feeding back a voltage at the third node and a voltage at an output node to maintain voltage at the output node at a desired bandgap reference voltage.

19. The method of claim 18, further comprising:
generating the voltage at the first node using a first element having a first complementary to absolute temperature (CTAT) voltage response curve;
generating the voltage at the second node using a second element having a second CTAT voltage response curve; and
wherein a difference between the first CTAT voltage response curve and the second CTAT voltage response curve has a proportional to absolute temperature relationship.

20. The method of claim 18, wherein feeding back a voltage at the third node and a voltage at an output node includes comparing the second current and the third current using a operational amplifier.
